(19) United States
(12) Patent Application Publication
(10) Pub. No.: US 2019/0088910 A1
(43) Pub. Date: Mar. 21, 2019

(54) Insulating Packaging Technique For Battery Cells

(71) Applicant: KUKA Industries GmbH, Augsburg (DE)

(72) Inventor: Peter Kiemstedt, Dasing (DE)

(21) Appl. No.: 15/533,071

(22) PCT Filed: Dec. 3, 2015
(86) PCT No.: PCT/EP2015/078481

§ 371 Date: Jun. 5, 2017

(30) Foreign Application Priority Data
Dec. 4, 2014 (DE) 10 2014 117 866.1

(51) Int. Cl. H01M 2/02; H01M 2/10

(52) U.S. Cl. CPC H01M 2/0277; H01M 2/0262; H01M 2/0275; H01M 2220/20; H01M 2/0267; H01M 2/1094; H01M 2/024

(57) ABSTRACT

A packaging technique for applying an insulating packaging to the housing of a battery cell. The insulating packaging is formed from a self-adhesive blank of insulating material by folding the blank onto the sides of the housing that are to be covered. The packaging technique involves a packaging method for automatically applying an insulating packaging, a battery cell including an insulating packaging, a packaging station for carrying out the method, and a supply device for supplying one or more blanks of insulating material.

### CROSS-REFERENCE

This application is a national phase application under 35 U.S.C. § 371 of International Patent Application No. PCT/EP2015/078481, filed Dec. 3, 2015 (pending), which claims the benefit of German Patent Application No. DE 10 2014 117 866.1, filed Dec. 4, 2014, the disclosures of which are incorporated by reference herein in their entirety.

### TECHNICAL FIELD

The invention relates to a technique for applying an insulating packaging onto a battery cell, in particular in the field of automated production and/or the packaging of battery modules, in particular for electric vehicles and hybrid vehicles, i.e. for vehicles with an at least partially electrically operated drive and for stationary battery storage. Such battery modules have capacities of several kilowatt hours (kWh), in particular more than 10 kilowatt hours.

### BACKGROUND

Within the battery modules, multiple battery cells are typically arranged side by side or one above the other with high packing density and, as the case may be, connected to one another at their connectors; output voltages in the range of several 100 V are possible. The battery cells comprise a housing, which may consist of an electrically conductive material, for example a deep-drawn aluminum housing.

For the aforementioned battery modules or battery cells, specifically, good electrical insulation between the individual cells and any surrounding components is essential. The battery modules can be exposed to strong climatic and mechanical effects and stresses over their lifetime as a result of their installation in the vehicle.

### SUMMARY

The object of the present invention is to demonstrate an insulating packaging technique, which can be implemented in a partially or fully automated manufacturing process and fulfills the requirements stated above.

The insulating packaging technique comprises at least one packaging method, a battery cell with an insulating packaging, as well as an insulting packaging station.

Within the context of the present invention it is assumed, for the sake of simplification, that a battery cell comprises a substantially cuboid shape, wherein the connectors of the cell are disposed on a common outer side. For further simplification, it is assumed that a plurality of battery cells are inserted side by side in a row or matrix arrangement in a battery carrier, wherein there may possibly be direct contact between two or more battery cells. The following description and the illustrations in the drawings are not limited to such a design. Rather, the insulating packaging technique can be used for any other types of battery cells and their relative arrangements. An insulating packaging may comprise one or more cutouts or openings, through which one or more connectors of a battery cell can protrude.

The insulated packaging according to the present disclosure is made of a self-adhesive and flexible insulating material, which is available, for example, in the form of a tape or a film. From this an insulating material blank is formed, which is applied onto the housing of a battery cell in an adhesive manner and folded onto each of the sides of the housing to be covered in a single- or multi-stage process. The insulating packaging preferably covers at least one of the sides opposite to the battery connectors (underside), as well as the adjacent circumferential sides of the housing (in particular the lateral and end surfaces). The insulating packaging may additionally cover a portion of the upper side of the housing, on which the battery connectors are disposed. The aforementioned definitions of the “underside”, the “lateral and end surfaces” and the “upper side”, which depend on the battery connectors, are chosen merely as examples to simplify the description of the packaging technique. They do not express any specification with respect to the spatial orientation of the battery cell during the packaging or in the installed state. They refer to a cuboid body as the basic shape of a battery cell as an example, and can be adapted to fit any other basic shape.

The aforementioned insulating packaging has a number of advantages. By using a self-adhesive material, the insulating packaging adheres permanently to the parts of the housing that are to be insulated. Consequently, gas cannot accumulate between the surface of the housing and the insulating material, and the formation of condensation between the battery housing and the insulating material, in particular, is prevented.

If a battery cell is moved relative to an adjacent battery cell or another adjacent object by external influences, which may occur as a result of external force and surface pressure, the adhesion of the insulating packaging to the battery cell ensures that any abrasion caused by rubbing can occur only on the exterior of the insulating packaging, on which a suitably hard-wearing material surface can selectively be provided or is provided. Displacement of the position of the insulating material and, in particular, folding, bunching or flipping up of the material can be prevented. The proposed insulating packaging therefore offers a high stability of the insulation in the face of mechanical and climatic effects or stresses.

The insulating tape or the insulating film may consist of a single layer or multiple layers. Plastics, which are highly durable and also resistant to heat and chemicals, can be used as the insulating material—in particular in the outermost surface layer. These plastics are superior to the normally used insulating varnishes with respect to their lifespan and mechanical resistance (in particular their elasticity and fracture toughness), and also exhibit low material thickness.

Since the insulating packaging rests against the housing of the battery cell in an adhesive manner, an insulated battery cell is easy and simple to handle in the further manufacturing process of a battery module. There is no need for special mechanical protection measures for storage and during installation, which lowers the transport, storage and production costs. Furthermore, in the event of a defect, the cells can be easily and individually replaced. Here too, the adhesion of the insulation has a positive effect because, as a result of the high mechanical strength, there is less risk of accidental damage to the insulation and a concomitant lower risk of electric shock for the technical staff.

Depending on the structure of a battery module, certain sides of the housing of a battery cell may be exposed to particularly high stresses. This can in particular be the underside and/or the circumferential sides of the housing, against which directly adjacent another battery cell abuts, i.e. the sides of the battery cell, on which there are generally no battery contacts.

The insulating packaging according to the present disclosure may include two or more insulating material blanks applied in an overlapping manner, for example, to provide those particularly stressed sides with an additional layer of insulation. In doing so, a respective outer layer of insulating material layer can be placed onto a previously or simultaneously applied inner insulating material layer in an adhesive manner. The two insulating material layers can be made from the same or of different materials. The insulating packaging technique according to the present disclosure can further be combined with other insulating techniques, e.g. with the application of an insulating varnish on the housing or the additional application of a non-adhesive film packaging, in particular a film hood or a film tape.

A packaging method for the automated application of an insulating packaging according to the disclosure, a supply device for the supply of an insulating material blank and an associated insulating packaging station will be explained in the following with different design examples and with reference to the drawings.

### BRIEF DESCRIPTION OF THE DRAWINGS

Examples of the invention are illustrated schematically in the drawings. Shown are:

FIG. 1 is a plan view of an insulating packaging station according to a first design variant;

FIGS. 2 and 3 are detailed representations of a supply device and a cutting station in an oblique view;

FIGS. 4 and 5 are perspective views of two process steps within a packaging method according to a first design variant;

FIG. 6 is a schematic side view of a supply device according to the first design variant;

FIG. 7 is a comparison of an insulating material blank in the prepared state as well as in a state in which it is partially folded onto a battery housing;

FIGS. 8 and 9 are schematic side views of an active folding table for folding an insulating material blank onto a battery cell housing;

FIG. 10 is a side view onto a supply device according to a second design variant;

FIGS. 11 and 12 are perspective views of process steps in a packaging method according to a second design variant;

FIGS. 13 to 15 are explanatory illustration for a method for preparing an additional packaging in the form of a hood or a half-open carton.

### DETAILED DESCRIPTION

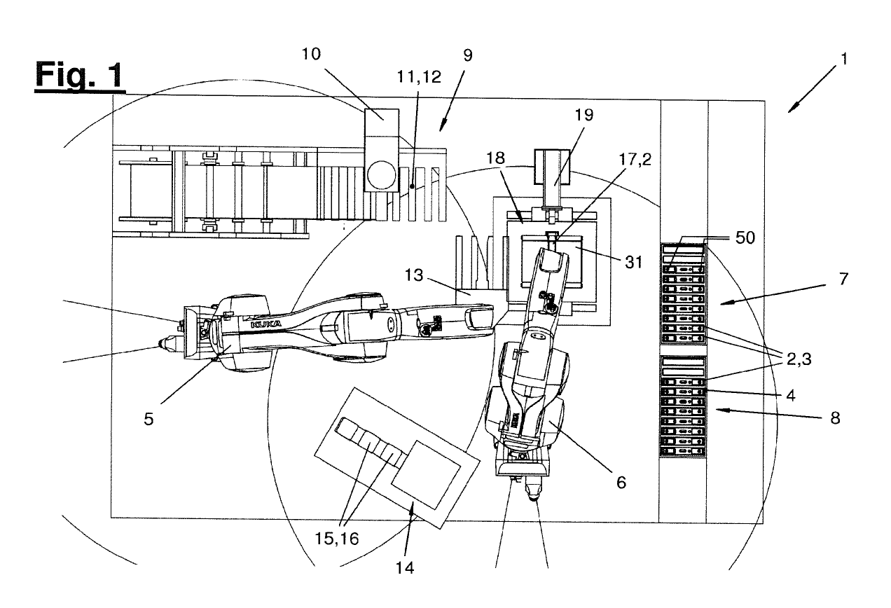

A packaging method executed by an insulating packaging station (1) will be described in the following with reference to FIGS. 1 to 9. An alternative or complementary second design variant will be outlined further below.

The insulating packaging station (1) according to FIG. 1 comprises a supply device (9) for supplying an insulating material blank (31), possibly an additional cutting station (14), and a folding table (18). The insulating packaging station (1) preferably further comprises one or more manipulators (5, 6) for conducting handling operations within a packaging process. The manipulators can be configured as desired. Two manipulators (5, 6), which are designed as multiaxial jointed-arm robots and carry one or more tools disposed on a robot hand, are provided in the outlined example. The jointed-arm robots preferably comprise five, six or seven separately controllable motion axes.

The first manipulator (5), shown on the left in FIG. 1, carries a handling tool (13) for picking up, moving and possibly putting down an insulating material blank (31) and/or an insulating material tape, in particular a tape end to be pulled off.

The manipulator (6), shown on the right in FIG. 1, carries a gripping tool (17) for picking up and guiding at least one battery cell (2). The gripping tool (17) is configured to pick up a battery cell (2) in the area of the upper side, i.e. the area of the connectors (50) to be left uncovered by the insulating packaging (4). A different gripper technology can alternatively be provided that picks up a battery cell at a different location, i.e. at other points of contact. The battery cell can be picked up and moved by magnetic force, for example, or by a suction gripper.

A battery cell (2) can include electrical connectors (50), as well as, if necessary, connectors for the supply of an electrolyte, etc. These connectors can be disposed on multiple sides of the housing of the battery cell (2). The collective arrangement of all the connectors on one side (referred to here as the upper side) favors the application of a well-insulating and durable insulating packaging and represents a preferred design.

In the packaging process, the battery cells (2) can be delivered, and discharged after application of the insulating packaging (4), in any desired manner. FIG. 1 shows an example of a battery cell supply (7) and a battery cell tray (8) in the form of magazines. Alternatively, a direct placement of battery cells (4) provided with an insulating packaging (4) into a module carrier to form a battery module can be performed.

The manipulator-guided tools (13, 17) can be configured as desired. They can have active components, such as suction or gripping means, which are served via separate drives, or external media or energy supplies. Alternatively, they can be supplied with media or power lines provided by the manipulators. Control of the suction or gripping means is preferably performed via a manipulator or station control.

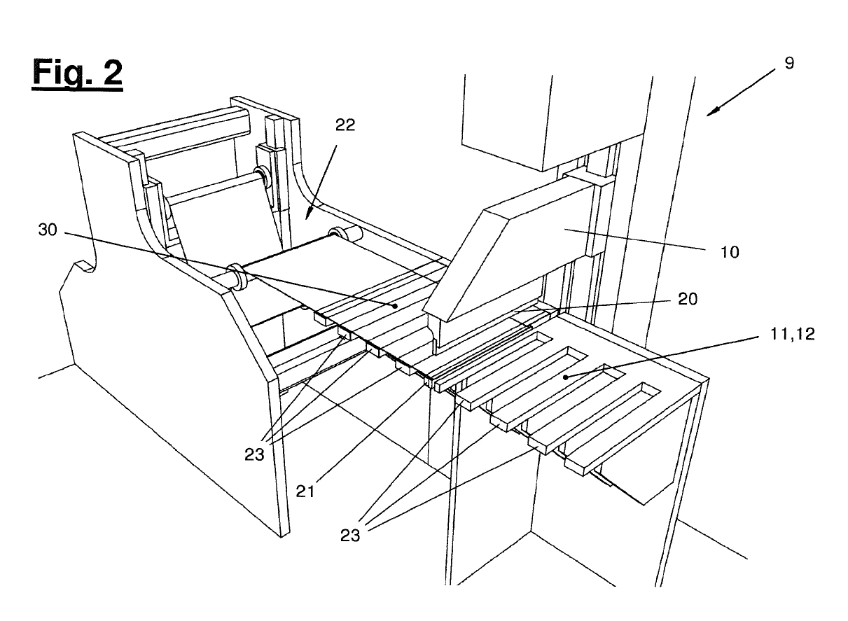

FIG. 2 shows a device (9) for supplying an insulating material blank (31) according to a preferred design variant. The supply device (9) comprises a tape feed (22) with a tape storage (27) (not shown here). It further comprises a supply area (30), a layout area (11) and a trimming device (10).

By way of example, it is further assumed that an insulating material is processed in the form of a self-adhesive tape, which is stored on rolls or coils and pulled off said rolls or coils during the packaging process, trimmed and made available as blanks. An insulating material can alternatively be supplied in the form of pre-trimmed tape strips and trimmed. Again alternatively, prefabricated insulating material blanks can be used.

In FIG. 2, one end of the insulating material tape, which can be pulled off from the tape feed (22), is held on the supply area (30). The tape can be held on the supply area in any way desired, in particular available to be picked up by the manipulator (5). Holding means in the form of one or more suction surfaces (12) are preferably provided there.

The tape can generally be pulled off or conveyed from the supply area (30) to the layout area (11) in any way desired. A separate conveyor or pulling device, for example, can be provided for this purpose. In the example discussed here, the pulling of the tape end from the supply area (30) to the layout area (11) is effected by the handling tool (13) guided by the manipulator (5) and an appropriately controlled movement of the manipulator (5), making a separate pulling device unnecessary.

As is apparent from a comparison of FIGS. 2, 4 and 6, the supply area (30) and the layout area (11) always comprise a shape that matches that of the handling tool (13). The supply area (30) and/or the layout area (11) are formed by spaced crosspieces (23). The aforementioned holding means, in particular the suction surfaces (12), can be provided on these crosspieces (23).

The handling tool (13), which is preferably designed as suction grippers, comprises a holding area with a comb-shaped structure (24). The comb-shaped structure (24) is in particular complementary to the crosspieces (23) of the supply area and/or the layout area (11). In the example shown, the complementary configuration is such that the struts of the comb (24) are set at such distances from one another that they can reach through between the crosspieces (23) of the supply and/or layout area (30, 11). A complementary configuration is characterized in that, in a coplanar (coplanar=parallel and in a common plane) arrangement, a supply area (30) or a layout area (11) form a common surface with the holding area of the handling tool (13).

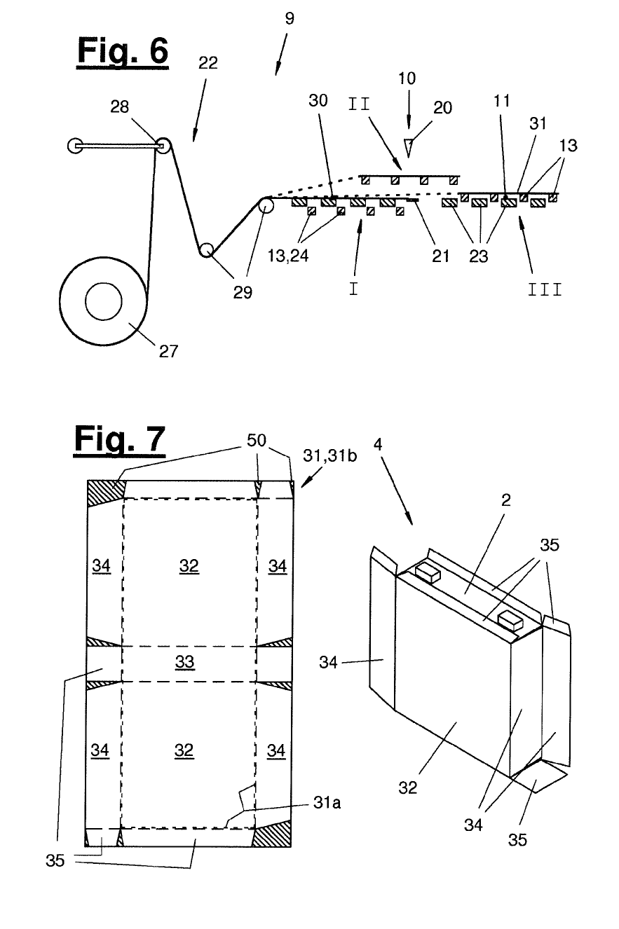

The reaching of the struts of the comb (24) through the crosspieces (23) is explained with reference to FIG. 6. The struts of the comb (24) and the crosspieces (23) are shown there in cross-section. The handling tool (13) is shown in three positions (I, II, III).

In position (I), the handling tool (13) is located directly below the supply area (30). A tape end of the insulating material is held on the supply area (30) (as shown as an example in FIG. 2). In the event of an upward movement of the handling tool (13), the struts of the comb (24) can reach through between the crosspieces (23) and are brought into contact with the tape. When the struts of the comb (24) are aligned with the crosspieces (23) in a coplanar manner, the handling tool (13) and the supply area (30) form a common surface.

By deactivating the holding means on the supply area (30) and activating the holding means, in particular the suction means, on the handling tool (13), the tape end can be picked up by the handling tool (13). Carrying along with it the tape end, the handling tool (13) can be moved over position (II) to position (III). In the course of this movement, the insulating material is pulled further, and in particular released or pulled off from the tape feed (22).

The tape feed (22) may be configured as desired. In the illustrated example, it comprises a tape storage (27) in the form of a film storage or a coil. The tape is guided from the film storage over a tensioner (28) (also referred to as a dancer) and, if needed, one or more rollers (29) to the supply area (30). The tensioner (28) forms a tape loop, which, during transport of the tape end from the supply area (30) to the layout area (11), can be shortened by releasing the required length of material. When the free end of the tape is fixed on the supply area (30), the tape loop can be enlarged by lifting the tensioner (28) to pull additional tape material from the roll (27). If necessary, this can be performed in a slow and controlled manner. In the course of the tape end being taken up by the handling tool (13) and the further movement to the layout area (11), the required length of tape can preferably be provided purely by the shortening of the tape loop and the simultaneous lowering of the tensioner (28), so that this movement can take place comparatively quickly and with low tensile forces. The unspooling of the tape from the film storage (27) and the pulling out from the tape loop can thus be performed in temporally separated cycles. Unwanted slipping of the tape end relative to the handling tool is thus prevented. Furthermore, in the event of any slipping of the tape end on the supply area (30) during unspooling, a readjustment can be made by making contact with and moving the handling tool (13). Suitable measurement equipment may be provided on the supply area (30) and/or the handling tool (13) to determine a position of the tape end.

A trimming device (10) is provided between the supply area (30) and the layout area (11). A portion of the tape end is cut off by means of the trimming device (10) and made available as an insulating material blank (31) at the layout area (11). Trimming can take place after or during the movement of the tape end from the supply area (30) to the layout area (11). In the illustrated examples the trimming device (10) is formed by a cutting knife (20), which optionally interacts with a counter surface (21). Any other desired configuration of a trimming device (10) can alternatively be provided; for example a punch tool, which also creates cutouts (50) in the insulating material blank (31), parallel or in addition to trimming. Other design options for trimming and cutting, which can be combined as desired in terms of the devices and the process, are described further below.

According to an alternative design variant (not shown), a supply device (9) can manage without a separate layout area (11). The trimming of the tape end to form an insulating material blank (31) can then be performed in the configuration of the handling tool (13) shown as position (III) in FIG. 6, wherein the tape end is preferably held under tension or stretched by the handling tool (13) with respect to the supply area (30).

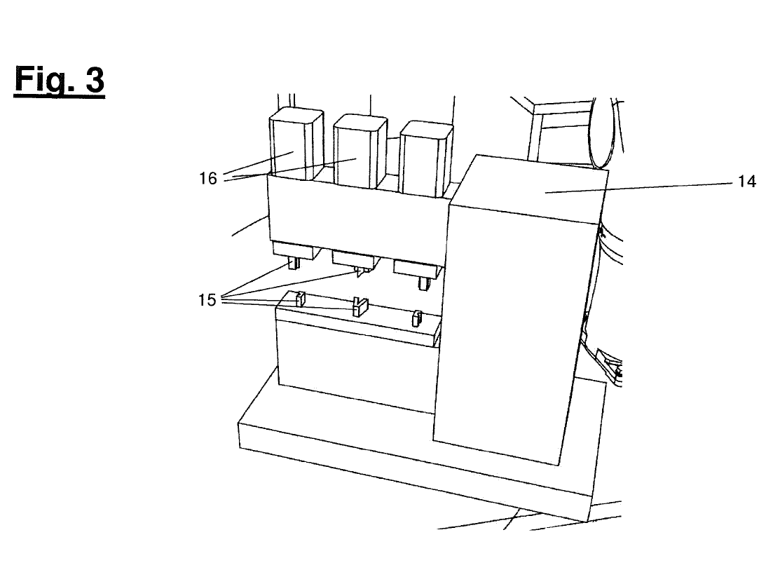

If necessary, a trimmed insulating material blank (31) can be moved to a cutting station (14) by the handling tool (13). A preferred design variant of such a cutting station (14), which in this case is configured as a separate station, is shown in FIG. 3. At the cutting station (14), the insulating material blank (31) can be provided with cutouts (50) to form separately foldable surface areas (32, 33, 34, 35) in the cutout (31). For this purpose, the cutting station (14) can comprise one or more suitable cutting tools (15) and, if necessary, associated drives (16). The cutting tools (15) are particularly preferably configured as punch tools with a movable punch and a corresponding die. Any other cutting tools can alternatively be provided. The described cutting tools can alternatively or additionally be provided on the supply device (9), and can be actuated parallel to, or temporally before or after, trimming.

The blanks (50) may, for example, have the shape shown as shaded areas in FIG. 7. They preferentially serve to form subareas to be provided within the insulating material blank (31). Any other shape of blanks and separately foldable surface areas (32, 33, 34, 35) can alternatively be formed. The shape of the insulating material blank (31), the surface areas (32, 33, 34, 35), and the cutouts (50), can in particular be selected as a function of the shape and size of the housing (3) of a battery cell (2) to be packaged as well as the surfaces to be covered.

In the example shown in FIG. 7, the blank (31) comprises a first partial surface (33), which substantially forms the center of the blank (31) and is to be positioned on the bottom surface of the housing (3). Adjacent to this on the top and on the bottom are two partial surfaces (32), intended to cover of the (main) lateral surfaces of the housing (3) on which other battery cells can abut the battery module. Connecting to each of these partial surfaces (32) then are two left and right adjacent subareas (34), which are provided to cover the front surfaces (lateral surfaces) of the housing (3). One or more edge folds (35) may additionally be provided, which effect an additional insulation of abutting edges or folding edges.

A battery cell (2) is preferably picked up by a manipulator (5, 6) and placed against the insulating material blank. This can be performed in a variety of ways and at a variety of locations.

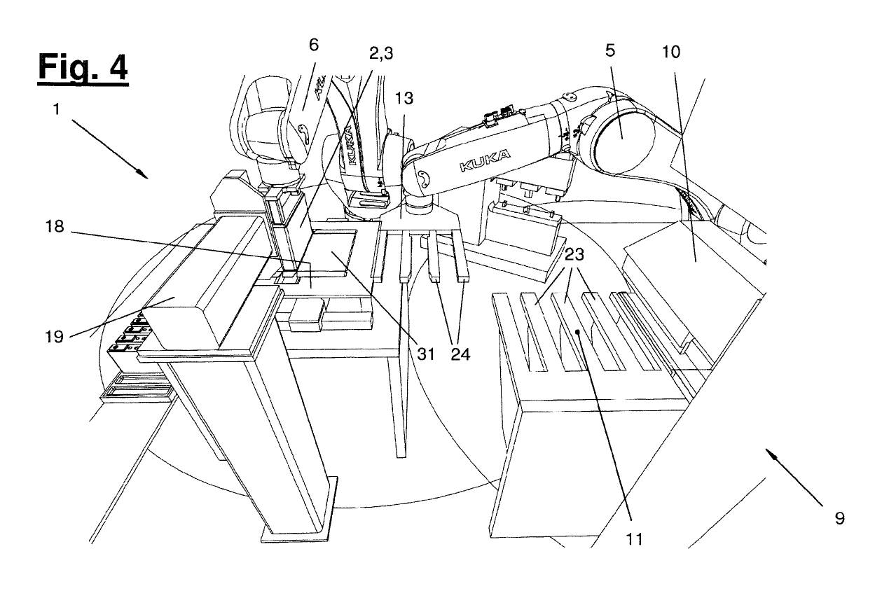

According to a first design variant, the battery cell (2) can be placed in an adhesive manner onto an insulating material blank (31), while said insulating material blank is being held on the handling tool (13). In doing so, the handling tool (13) can in particular be positioned next to a folding table (18) (see FIG. 4). The battery cell (2) can then be moved onto the folding table (18) carrying the insulating material blank (31) along with it.

FIG. 4 depicts a situation immediately after a battery cell (2) is placed onto an insulating material blank being held on the handling tool (13). The battery cell (2), carrying along with it the blank (31), was subsequently moved into the shown position on the folding table (18).

In the example discussed here, the folding table (18) is preferably configured as an active folding table, and comprises one or more folding means with which one or more partial surfaces (32, 34, 35) of the blank (31) can be folded onto the housing. These folding means can in particular be disposed on, or with respect to the supporting surface of the folding table (18) underneath, the insertion opening (25) and, if necessary, have their own or derived drives or elastic delivery devices. An insertion opening can in particular (25) comprise one or more folding edges (26) on its edge, wherein (active) folding rolls (36) and/or folding spatulas (37) are provided below the insertion opening (25).

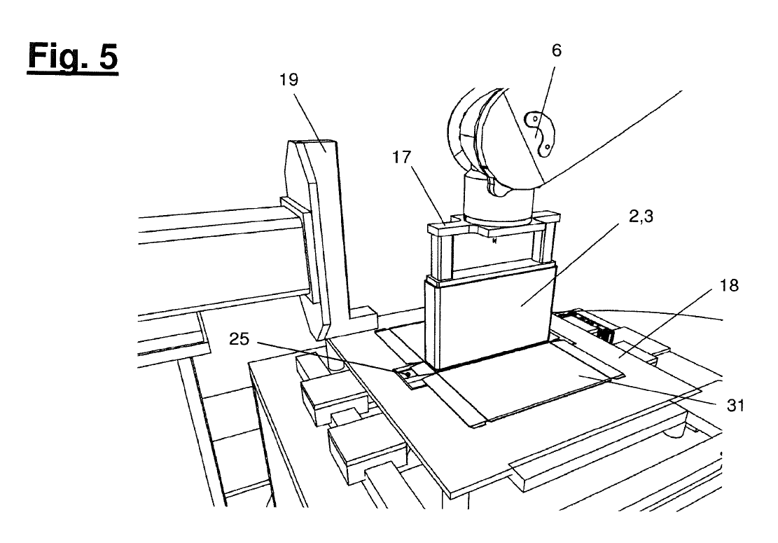

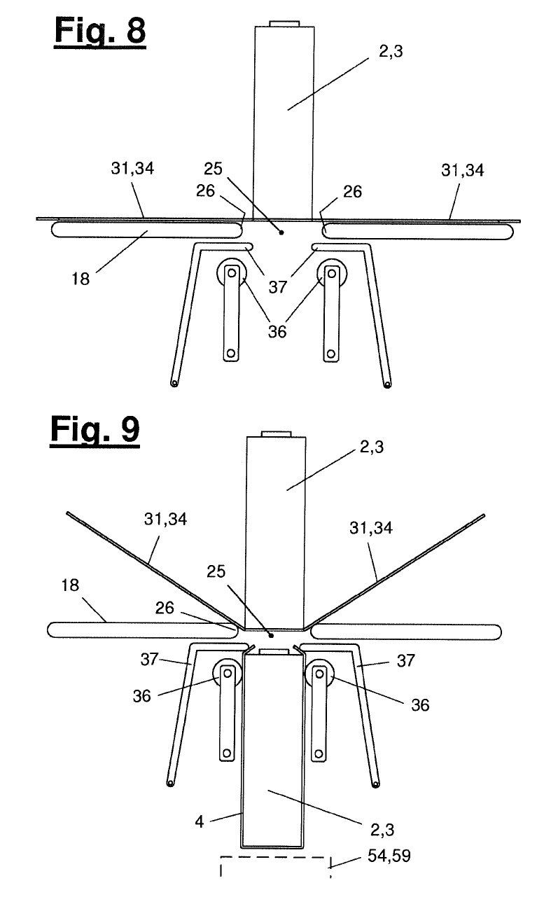

FIG. 5 shows a positioning of a housing (3) of a battery cell (2) directly above an insertion opening (25) of the folding table (18). An insulating tape blank (31) is applied to the underside (33) of the housing (3) in an adhesive manner. A folding of the partial surfaces (32) for the main lateral surfaces of the housing (3), as well as the adjacent edge fold (35) on the upper side, is illustrated in FIGS. 8 and 9 (see blank depictions in FIG. 7).

When the battery cell (2) is moved into the insertion opening (25), the outwardly projecting partial surfaces (32) of the insulating material blank (31) are held back over the folding edges (26), so that they stand upright relative to the bottom surface (33) of the housing (3) or against the main lateral surfaces. In a continuation of the movement, the folding can if necessary be supported by pressure rollers (36) and/or folding spatulas which can be placed against the surface. The pressure rollers (36) in particular support a full-surface folding of the insulating material onto the lateral surfaces of the housing (3) that is as bubble-free as possible. Edge folds (35) can for example be placed around the upper side of the housing (3) with the folding spatulas (37) and, if necessary, pressed onto the upper side. Holding means, in particular suction surfaces, can be provided on the surface of the folding table (18) if necessary. These holding means can keep the partial surfaces (34, 35) of the blank (31) to be folded under tension during the plunging motion of the battery cell into the insertion opening (25), by means of which a controlled linear application of the insulating material in the area of the pressure rollers (36) or the folding spatula (37) is supported.

In the example discussed here, only the partial surfaces on the folding table (18) intended for the main lateral surfaces (34) are placed against the housing (3). Partial surfaces of the blank (31), in particular the edge folds (35) adjacent to the bottom surface (33) and/or the front surface fold (34), can alternatively or additionally be placed against the housing (3) with the aid of appropriate devices on the folding table (18) (see FIG. 7, right).

The battery cell (2), provided with an at least partially adhesively applied insulating material blank (31), can further alternatively or additionally be moved to a static folding mandrel (19). The manipulator (6) can guide the battery cell (2) along the folding mandrel (19) in such a way that partial surfaces (32, 34, 35) of the blank (31) are folded onto the housing (3). Depending on the configuration of the material blank (31) and the design of the housing (3), the use of one or more folding tables and one or more folding mandrels, exclusively or in combination, can be foreseen. In the shown first design variant, in particular the partial surfaces (34) intended for the front surfaces of the housing (3) are successively and in an overlapping manner folded onto the housing (3) using the folding mandrel (19) (see right illustration in FIG. 7).

An additional packaging (54), which enfolds the folded insulating packaging (4), can be applied to the battery cell (2). A pulling device (59) is preferably provided for the supply of the additional packaging. The application of the additional packaging and a preferred configuration of a pulling device (59) are discussed further below.

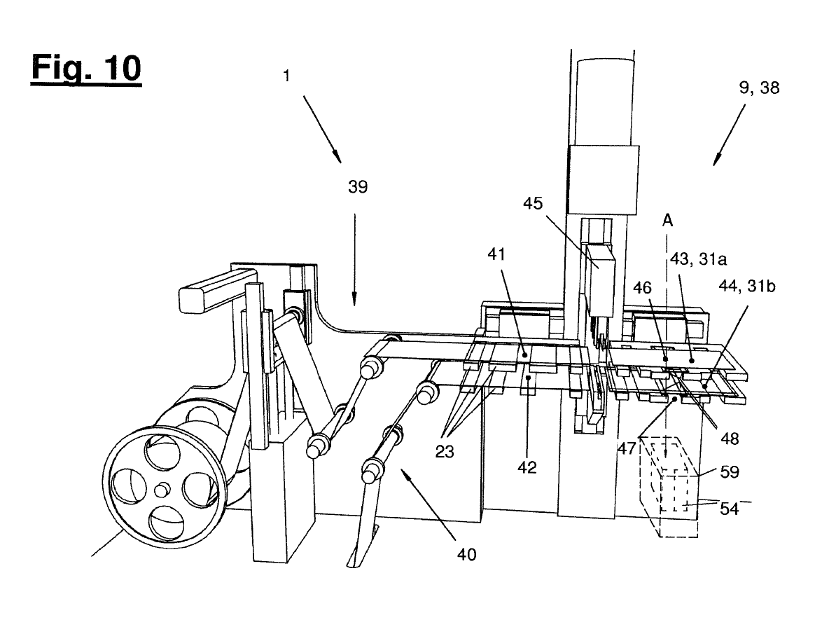

An alternative second design variant of a packaging method and a supply device (9) are discussed in the following with reference to FIGS. 10 to 12. In this example, two or more insulating material blanks (31a, 31b) are applied to a battery cell (2) in an overlapping manner to form the insulating packaging (4). The two or more insulating material blanks (31a, 31b) are in particular prepared on two substantially parallel aligned layout areas (43, 44) and folded onto the housing (3) in one continuous motion in direct succession and overlapping one another. This type of application of an insulating packaging is particularly time and space efficient.

FIG. 10 depicts the supply device (9) according to the second design variant in perspective side view. In this case, the supply device (9) preferably comprises an integrated cutting and/or cutting and/or folding device. The named functions will be discussed in more detail in the following.

The supply device (9) comprises a first supply area (41) and a second supply area (42), disposed substantially parallel to and below the first. It further comprises a first layout area (43) and another second layout area (44), disposed substantially parallel to and below the first. A cutting device (45), which can simultaneously serve as a trimming device, is provided between the supply areas (41, 42) and the layout areas (43, 44). Functionally, it can be configured in a manner analogous to the above discussed trimming device (10).

A first insulating material tape is guided to the first supply area (41) by a first tape feed (39). The configuration and function of the first tape feed (39) can be the same as that of the above described tape feed (22).

The supply device (9) according to FIG. 10 further comprises a second tape feed (40), by means of which a second insulating material is guided to the second supply area (42).

The supply areas (41, 42) and/or the layout areas (43, 44) can also be formed by crosspieces (23), on which holding means are disposed, in particular suction surfaces (12). Their shape corresponds to the shape of the handling tool (13), preferably in the manner discussed above.

The first layout area (43) and the second layout area (44) each comprise an insertion opening (46, 47). Said insertion openings (46, 47) can preferably be delimited by one or more folding edges and/or one or more pressure rollers (48). A first insertion opening (46) at the top/first layout area (43) can in particular be delimited by folding edges and a second insertion opening (47) can be delimited by pressure rollers (48), so that functionally a configuration according to the folding table shown in FIGS. 8 and 9 is achieved.

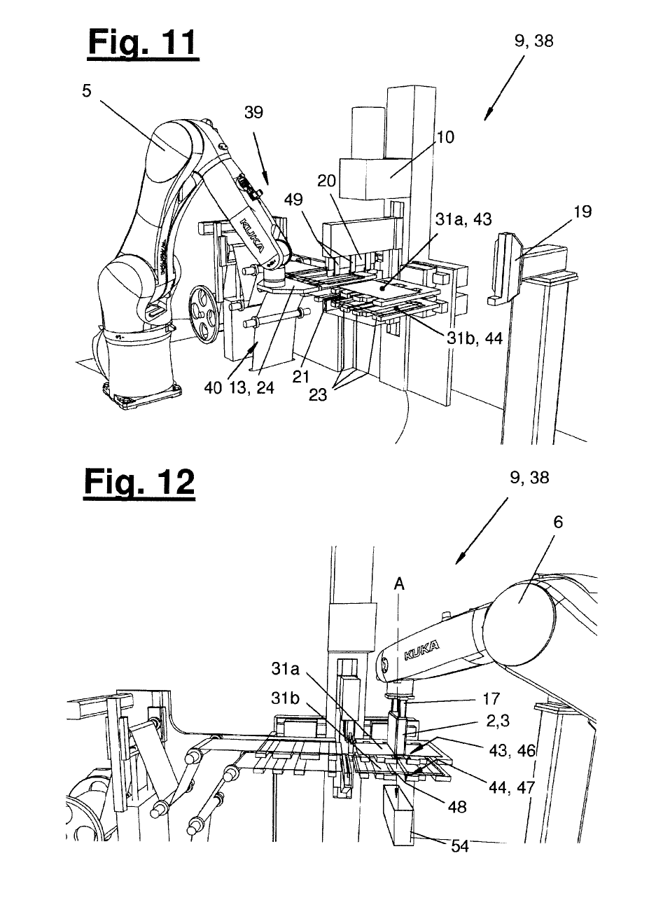

As shown in FIG. 11, a handling tool (13) formed in accordance with the design described above can be guided by a manipulator (5), and convey or pull a tape end from the first supply area (41) to the first layout area (43). During or after this pulling movement, the tape end can be trimmed to form a first insulating material blank (31a). In addition, by means of an appropriate movement of the same or a further handling tool (13), a second tape end of the second insulating tape can be pulled from the second supply area (42) to the second layout area (44) and, during or after this movement, trimmed to form the second blank (31b). Correspondingly, a first blank (31a) and a second blank (31b) can be laid out on the first and the second layout area (43, 44) in an overlapping manner.

In the example shown in FIGS. 10 to 12, the second insulating material blank (31b), which is made available on the lower layout area (44), is configured in an analogous manner to blank (31), which is described above and shown on the left in FIG. 7. The other insulating material blank (31a), which is made available on the top layout area (43), can have the same or a different configuration. In the example shown, this blank (31a) is configured only for an additional covering of the underside and the main lateral surfaces of the battery cell (33). Said blank thus comprises only the associated partial surfaces (32, 33), and does not have to be to be provided with cutouts (50) (see dotted boundary line on the left in FIG. 7). Any other desired configurations for the blanks (31a, 31b) can alternatively be provided.

A battery cell (2) can be guided to the insulating material blank (31a) made available on the first layout area (43) and placed upon it in an adhesive manner. This situation is depicted in FIG. 12. The battery cell (2) with the adhesively applied first insulating material blank (31a) can subsequently be moved into the first insertion opening (46). In doing so, the partial surfaces (32) of the blank (31a) intended for the covering of the main lateral surfaces are placed against the battery cell (2) or its housing (3) analogously to the depictions in FIGS. 8 and 9. In continuation of this movement, the battery cell (2) is moved to the second layout area (44) and there placed against the second insulating material blank (31b). Continuing the movement still further, the battery cell (2) is moved into the second insertion opening (47) on the second layout area (44). In doing so, the two insulating material blanks (31a, 31b) are folded onto the housing (3) of the battery cell (2) in an overlapping manner. With the aid of holding means provided on the layout areas (43, 44), in particular the suction surfaces (12) described above, the blanks (31a, 31b) can be tensioned during folding to support a controlled, and preferably linear, application in the manner described above.

If necessary, further partial surfaces (34, 35) of the blanks (31a, 31b) can subsequently be folded onto the housing (3) by guiding along a folding mandrel (19) as already discussed above.

Modifications of the invention are possible in a variety of ways. The features shown and/or described for the individual design variants can in particular be combined, swapped, added or omitted as desired.

A cutting station (14), or one or more cutting tools (15) for the creation of cutouts (50) in a blank (31a, 31b), can be disposed on the supply device (9), and in particular integrated into the trimming device (10). As an example FIG. 11 depicts cutting tools (49) disposed next to a cutting knife (20). According to the second design variant, additional folding means, in particular folding rollers or folding spatulas, can further be provided on a supply device (9).

One or more additional layers of packaging (54), which lie on top of the folded on insulating packaging (4), can be applied onto the battery cell (2). Such additional packaging can, for example, serve to provide additional sealing against moisture or liquids and, for example, consist of a film or a coated cardboard material. Furthermore, the additional packaging (54) can likewise also consist of an insulating material.

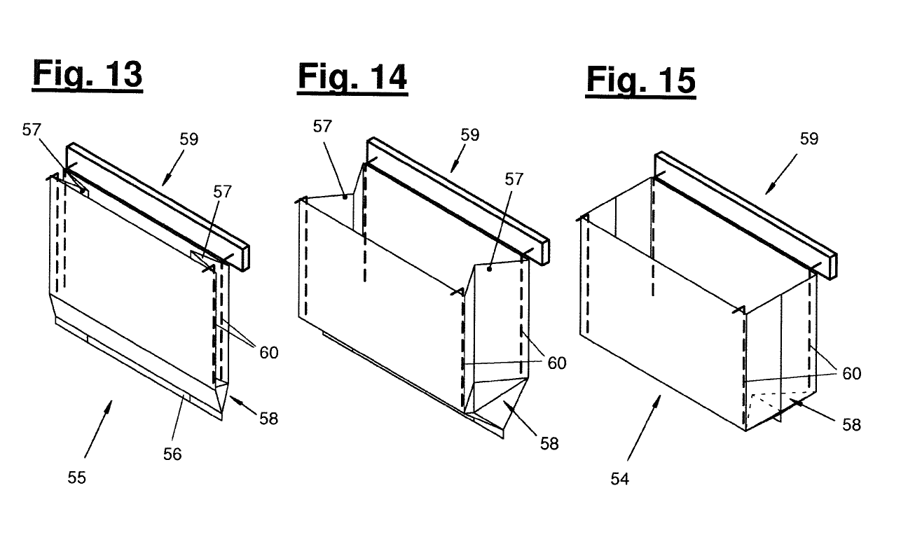

Such an additional packaging (54) can particularly preferably consist of a hood, in particular a stretch hood, or a half-open carton. FIGS. 13 to 15 show an example of a method for preparing a stretch hood (54) from a sleeve blank (55). A half-open carton can be formed and prepared from a carton blank in a similar manner.

The sleeve comprises two collapsed sides, which form the side walls (57) when unfolding. In FIG. 13, the sleeve is shown in a flattened position with the collapsed side walls (57). The lower end of the sleeve is closed. The closure (56) can, for example, be created by welding, gluing or another suitable method. In the example shown, the sleeve blank (55) is in the form of a prefabricated article.

A pulling device (59) is configured to unfold the flattened sleeve blank (55). This procedure is illustrated in the transition from FIG. 13 to FIGS. 14 and 15. In the shown example, the pulling device (59) respectively comprises two fingers (60), which reach into the interior of the sleeve and are moved toward the outside to unfold the sleeve. Grippers can alternatively be provided for this purpose. When the sleeve blank (55) is unfolded, the collapsed side walls (57) are pulled apart and thereby opened. In doing so, a lower area of the side walls (57) unfolds in the shape of a tetrahedron cladding or a triangle fold (58).

The fully unfolded condition of the sleeve blank (55) is shown in FIG. 15. The unfolded sleeve (55) forms a hood that is open toward the top and into which a battery cell (2) can be inserted.

The sleeve (55) can be made of a flexible material and form a stretch hood, which can be stretched beyond the size of the housing (3) of the battery cell (2). While the battery cell (2) is being inserted into the hood or when it is inserted, the fingers or grippers (60) can be removed from the hood, whereby the hood elastically snugs around the battery cell (2). The additional packaging (54) thereby enfolds the insulating packaging (4) which has been folded onto the battery cell.

Within the packaging process, the additional packaging (54) can be applied after the insulating packaging (4) has been folded on. The application of the additional packaging particularly preferably takes place directly after the insulated packaging has been folded on and in particular in a combined movement (A).

FIG. 9 shows an example of a pulling device (59) behind the insertion opening (25) on the folding table (18). The battery cell (2) can be moved into the pulling device (59) to apply the additional packaging (54) directly after the insulating packaging (4) is folded on.

An alternative arrangement of the pulling device (59) on the supply device (9) is shown in FIGS. 10 and 12. The pulling device (59) can advantageously be positioned behind the first and second insertion opening (46, 47) in the direction of the insertion movement (A). One or more insulating material blanks (31a, 31b) can thus be folded onto the battery cell (2) in one continuous movement and, in a continuation of the movement (A), the additional packaging (54) can be applied directly on top of it. The movement of the battery cell (2) is thereby performed by the manipulator (6).

While the present invention has been illustrated by a description of various embodiments, and while these embodiments have been described in considerable detail, it is not intended to restrict or in any way limit the scope of the appended claims to such detail. The various features and method steps shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Insulating packaging station
2 Battery cell
3 Housing/aluminum housing
4 Insulating packaging
5 First manipulator/industrial robot
6 Second manipulator/industrial robot
7 Battery cell supply
8 Battery cell tray
9 Supply device
10 Trimming device
11 Layout area
12 Suction surface
13 Handling tool/suction gripper
14 Cutting station
15 Notching tool
16 Drive
17 Gripping tool
18 Folding table (active)
19 Folding mandrel (passive)
20 Cutting knife
21 Counter surface
22 Tape feed
23 Crosspieces
24 Comb/comb-shaped structure
25 Insertion opening
26 Folding edge
27 Tape storage/film storage/coil
28 Dancer/tensioner
29 Guide rollers
30 Supply area
31 Insulating material blank
31a First blank
31b Second blank
32 Lateral surface
33 Bottom surface
34 Front surface
35 Edge fold
36 Pressure roller
37 Folding spatula
38 Integrated cutting, notching, and folding device
39 First tape feed
40 Second tape feed
41 First supply area
42 Second supply area
43 First layout area
44 Second layout area
45 Cutting device/trimming device
46 First insertion opening
47 Second insertion opening
48 Folding edge/pressure roller
49 Cutting tool
50 Cutout
51 Battery connectors
52 Underside/side across from the connectors
53 Circumferential sides
54 Additional packaging/stretch hood/carton
55 Sleeve cutout/carton cutout
56 Closure
57 Collapsed side wall
58 Triangle fold
59 Pulling device
60 Gripper/finger
A Direction of the insertion movement

1-49. (canceled)

50. A packaging method for applying an insulating packaging to a battery cell, the method comprising:
providing an insulating material blank comprising a flexible self-adhesive tape or a flexible self-adhesive film;
folding the insulating material blank onto a housing of the battery cell using a robotic manipulator to thereby form the insulating packaging.

51. The packaging method of claim 50, further comprising:
picking up the battery cell with the robotic manipulator;
moving the battery cell with the robotic manipulator; and
placing the battery cell against the insulating material blank with the robotic manipulator.

52. The packaging method of claim 50, further comprising:
cutting one end of an insulating material tape to length at a supply device to thereby form the insulating material blank.

53. The packaging method of claim 52, further comprising:
picking up one end of the insulating material tape in a supply area with a handling tool of the robotic manipulator; and
moving the insulating material tape into a position designated for cutting.

54. The packaging method of claim 52, further comprising:
cutting the insulating material tape to form the insulating material blank, wherein the cutting is performed after or during movement of a tape end from a supply area to a layout area, in particular wherein the insulating material blank is moved to a cutting station by a handling tool of the robotic manipulator.

55. The packaging method of claim 54, further comprising:
providing cutouts in the insulating material blank at the cutting station to thereby form separately foldable surface areas in the blank, in particular when the insulating material blank is positioned on the handling tool adjacent to a folding table.

56. The packaging method of claim 50, further comprising:
placing the housing of the battery cell onto the insulating material blank in an adhesive manner while the insulating material blank is held on a handling tool of the robotic manipulator; and
moving the battery cell onto a folding table while the insulating material blank is carried along with the battery cell, in particular moving the battery cell with the adhesively attached insulating material blank into an insertion opening of a folding table.

57. The packaging method of claim 56, further comprising:
folding further partial surfaces of the insulating material blank onto the housing with at least one of folding edges, pressure rollers, or folding spatulas, each of which are disposed on the edge of the insertion opening for placement against the insulating material blank.

58. The packaging method of claim 57, further comprising:
moving the battery cell with an at least partially adhesively attached insulating material blank to a folding mandrel; and
guiding the battery cell along the folding mandrel to fold further partial surfaces of the insulating material blank onto the housing.

59. The packaging method of claim 51, wherein placing the battery cell against the insulating material blank comprises placing the battery cell against the insulating material blank in an adhesive manner wherein the insulating material blank is disposed on a layout area;
in particular wherein the battery cell with an adhesively attached insulating material blank is moved into an insertion opening on the layout area;
in particular wherein a battery cell with a first adhesively attached insulating material blank is moved through a first insertion opening on a first layout area and, in continuation of the movement, is placed in an adhesive manner on a second insulating material blank.

60. The packaging method of claim 50, further comprising:
providing the battery cell having a folded insulating packaging with additional packaging, in particular in the form of a hood, a stretch hood, or a half-open carton;
in particular wherein the additional packaging is supplied by a pulling device and the battery cell is inserted into an opening of the additional packaging.

61. A battery cell for use in a multi-cell battery system, in particular a battery module for a vehicle with an at least partially electrically operated drive, the battery cell comprising:
a housing that is insulated with respect to adjacent battery cells;
the insulation is formed by an insulating packaging made from a self-adhesive flexible insulating material blank that covers at least one main side of the housing, in particular a side of the housing positioned across from a battery connector;
the insulation further covering two or more adjacent circumferential sides of the housing, in particular all adjacent circumferential sides of the housing.

62. The battery cell of claim 61, wherein the insulating packaging is formed from at least two insulating material blanks that are applied in an overlapping manner.

63. The battery cell of claim 61, further comprising an additional packaging applied to the battery cell and overlapping the insulating packaging, in particular wherein the additional packaging is in the form of a hood, a stretch hood, or a half-open carton.

64. An insulating packaging station for applying an insulating packaging onto a battery cell, the insulating packaging station configured to:
provide an insulating material blank comprising a flexible self-adhesive tape or a flexible self-adhesive film; and
fold the insulating material blank onto a housing of the battery cell using a robotic manipulator to thereby form the insulating packaging.

65. The insulating packaging station of claim 64, further comprising:
a supply device including at least one of a trimming device or at least one cutting tool.

66. The insulating packaging station of claim 65, wherein the supply device comprises a tape feed with a tape storage for a self-adhesive insulating material, and wherein the supply device comprises a supply area, a layout area, and a trimming device, by which a portion of a tape end can be made available on the layout area in a severable manner and as an insulating material blank.
